(19) United States
(12) Patent Application Publication
(10) Pub. No.: US 2013/0264166 A1
(43) Pub. Date: Oct. 10, 2013

(54) METHOD FOR PRODUCING A FRICTION ELEMENT

(71) Applicant: Schaeffler Technologies AG & Co. KG, Herzogenaurach (DE)

(72) Inventors: Stefan Steinmetz, Essingen (DE); Constanze Franke, Bonn (DE); Markus Hesse, Karlsruhe (DE)

(21) Appl. No.: 13/910,227

(22) Filed: Jun. 5, 2013

Related U.S. Application Data
(63) Continuation of application No. PCT/DE2011/001999, filed on Nov. 17, 2011.

(30) Foreign Application Priority Data
Dec. 13, 2010 (DE) 102010054266.0

(51) Int. Cl. F16D 69/04

(52) U.S. Cl. CPC F16D 69/04
USPC 192/107 M; 156/60

(57) ABSTRACT

A method for producing a friction element, in particular a wet running friction disk in a motor vehicle, wherein during operation the friction element rotates about an axis of rotation. The friction element has a friction area and a connection area, and the friction element is connected to a friction element carrier in the connection area. The invention also relates to a friction element.

### INCORPORATION BY REFERENCE

The following documents are incorporated herein by reference as if fully set forth: International Application No. PCT/DE2011/001999, filed Nov. 17, 2011, and German Patent Application No. DE 102010054266.0, filed Dec. 13, 2010.

### BACKGROUND

The invention relates to a method for producing a friction body along with a friction body.

The field of application and purpose of use of the invention lie in the field of friction lining materials and friction disks for the area of application according to the respective formulation in dry-running or wet-running environments, advantageously as a wet-running lining disk in the area of dual clutches, converters, synchronization, differentials, and automatic transmissions.

EP 0 557 657 A1 discloses the application of a powdery adhesive material onto a metal carrier. The metal carrier is heated so that the adhesive material melts but is not cross-linked. A cured friction lining is pressed onto the adhesive material with heating and pressure, so that the adhesive is cross-linked and a friction element is produced in this way.

U.S. Pat. No. 3,738,901 A discloses a clutch plate that is operated in oil and has a friction lining made from a felt-like, fully reacted layer. This friction lining is bonded onto a metal carrier in an additional, separate step.

Typical wet-running linings are produced by paper-making machines and are fixed on a metallic carrier in an additional step by a bonding process after the complete production—that is, raw paper production and subsequent saturation together with a drying step. The metallic carrier, which usually is a stamped part, here also takes on a torque transfer function by means of a molded inner or outer toothed section.

The disadvantage of this established technology is the number of processing steps. In addition to a separate pressing, curing, and optional drying step, during the production of the friction lining that is not yet connected to the lining carrier, the lining carrier and friction lining are bonded in a separate processing step. Additional steps that are required include the coating of the lining or the carrier sheet with the adhesive and the sometimes necessary surface treatment, such as acid cleaning or abrasive blast cleaning, etc. of the carrier. The necessity for several processing steps causes significant costs in the production of the lining disk.

### SUMMARY

The object of the present invention is to present a simplification of the production process of a friction body.

This object is met by a method as well as a friction body according to the invention.

With respect to the method, the objective is met by the method described below.

According to the invention, a method is provided for producing a friction body, in particular a wet-running friction disk in a motor vehicle, wherein the friction body rotates about a rotational axis during operation, wherein the friction body has a friction area and a connection area, and wherein the friction body is connected to a friction body carrier by the connection area, wherein the friction body has a lining carrier, and wherein the lining carrier has a friction area and a connection area, and wherein the friction body has at least two paper blanks, wherein each paper blank has a friction area, and wherein a first paper blank is placed in the friction area and the lining carrier is placed in the friction area and a second paper blank is placed in the friction area one above the other in the axial direction, wherein the lining carrier is arranged axially between the first and the second paper blanks. According to the invention it is then provided that the first paper blank and the lining carrier and the second paper blank are pressed to a specified thickness in the friction area with heating and the reaction of the binding agent contained in the paper blanks to the friction body, wherein the binding agent contained in the paper blanks is still in a reactive state before the pressing.

In a particularly preferred embodiment of the invention, it is provided that the paper blanks are produced by a pulp molding method.

In a particularly preferred embodiment of the invention, it is provided that the paper blanks are in a moist state before the pressing.

In one preferred embodiment of the invention, it is provided that the lining carrier is a carrier sheet.

In another preferred embodiment of the invention, it is provided that the friction area of the lining carrier has recesses.

In one preferred embodiment of the invention, it is here provided that the pressing is a hot pressing process.

In another preferred embodiment, it is provided that, before the first paper blank, the lining carrier, and the second paper blank are placed one above the other, the lining carrier is provided at least partially with an adhesive that is still in the reactive state and the heating is performed during the pressing such that, in addition to the reaction of the binding agent contained in the paper blanks, a reaction of the adhesive is also realized.

In one preferred embodiment of the invention, it is provided that the friction body is also dried during the pressing.

In another preferred embodiment of the invention, it is provided, during the drying, the moisture is discharged as water vapor with the help of vacuum or negative pressure.

In another preferred embodiment of the invention, it is provided that the friction body carrier is a hub.

In another preferred embodiment of the invention, it is provided that the friction area has at least one friction surface with surface structuring.

In another preferred embodiment of the invention, it is provided that the two friction surfaces of the friction area have different surface structuring.

In another preferred embodiment of the invention, it is provided that the surface structuring is a groove geometry.

In another preferred embodiment of the invention, it is provided that the surface structuring is formed during the pressing and/or due to subsequent grinding.

In another preferred embodiment of the invention, it is provided that the friction surface is ground after the pressing.

With respect to the device, the object is met by the device described below.

According to the invention, a friction body is also provided, in particular, a wet-running friction disk in a motor vehicle, wherein the friction body rotates about a rotational axis during operation, wherein the friction body has a friction area and a connection area, and wherein the friction body can be connected to a friction body carrier by the connection area, wherein the friction body has a lining carrier, and wherein the lining carrier has a friction area and a connection area, and wherein the friction body has, for its production, at least two paper blanks, wherein each paper blank has a friction area, and wherein a first paper blank is placed in the friction area and the lining carrier is placed in the friction area and a second paper blank is placed in the friction area one above the other in the axial direction for the production of the friction body, wherein the lining carrier is arranged axially between the first and the second paper blanks. According to the invention, it is provided that then the first paper blank and the lining carrier and the second paper blank are pressed to a specified thickness in the friction area with heating and the reaction of the binding agent contained in the paper blanks to the friction body, wherein the binding agent contained in the paper blanks is still in a reactive state before the pressing and wherein the friction body is produced according to one of the methods described above.

According to the method according to the invention, the production of a friction body, for example, a lining disk with a carrier sheet, can be simplified, because the friction body according to the invention can be produced without the separate step that is provided for the bonding process. In a way that is different than that described in the prior art, the pressing, curing, bonding, and drying take place in a single processing step during the pressing.

### BRIEF DESCRIPTION OF THE DRAWINGS

Additional advantages and advantageous constructions of the invention are the subject matter of the following figure and also its description.

Shown in detail are:

FIG. 1 is a schematic diagram of the production method according to the invention for the friction body.

### DETAILED DESCRIPTION OF THE PREFERRED EMBODIMENTS

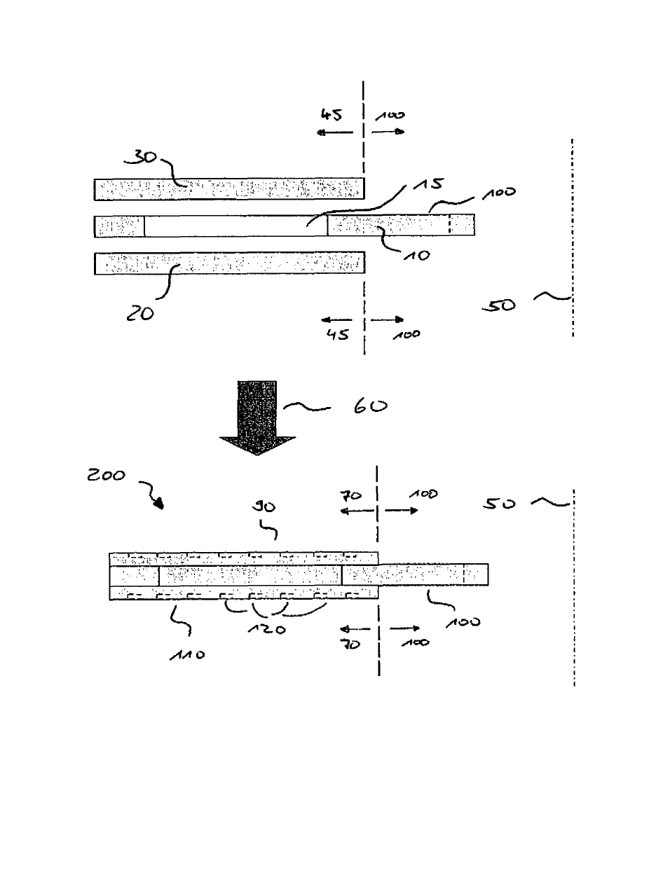

FIG. 1 shows schematically the production method according to the invention for the friction body.

The reinforcing carrier sheet 10 is located between two pulp-molding paper blanks 20, 30. Then the carrier sheet 10 and pulp-molding blanks are pressed together in a suitable hot-pressing and drying tool. Here, the pulp-molding paper blanks 20, 30 contain a binding agent—advantageously phenolic resin—in a state that is not fully reacted, that is, in a state that is still reactive. The binding agent in the paper blanks 20, 30 provides for an adhesive connection to the carrier sheet 10 after it reacts completely due to the hot-pressing process. The paper blanks 20, 30 are still moist before the pressing.

A pulp molding blank is understood to be a blank that is produced by a pulp molding method known to someone skilled in the art. Such a method is also described in the German Patent Application DE 10 2010 021 722.0. Here, a dispersion made from water and solids is suctioned onto a sieve-like surface, wherein the solids are deposited on the sieve-like structure. The shape of the sieve-like surface is selected so that the resulting blank assumes the desired shape—for example, an annular shape. In this way, stamping residue like that produced according to classical paper-making methods can be avoided in order to obtain the desired shape for the blank. Such a dispersion contains, in addition to water, for example, cotton fiber, aramid fiber, silicon dioxide, phenolic resin, and processing aids that are typical for the production of paper.

The first paper blank 20 is placed in the mold, then the carrier sheet 10 and another paper blank 30 are placed in a stack by placing the first paper blank 20, the carrier sheet 10, and the paper blank 30 one above the other in a desired way. The paper blanks 20, 30 are still moist. Then this package is pressed 60 in a suitable hot-pressing and drying tool to the desired thickness with the drying and reaction of the binding agent that is contained in the paper and is still not fully reacted, that is, is still reactive. The temperature during the pressing must be selected such that the binding agent reacts fully. The binding agent contained in the paper blanks 20, 30—advantageously phenolic resin—reacts fully and provides, in addition to the paper strength, also the bonding connection to the carrier sheet 10. The mold discharges the moisture that is still contained as water vapor, for example, with the help of vacuum or negative pressure.

The inserted carrier sheet 10 can contain recesses 15, in order to connect the two friction linings 20, 30 to the carrier sheet with a positive fit. Advantageously, the surface of the carrier sheet 10 is treated by acid cleaning or abrasive blast cleaning for increasing the strength of the connection.

The necessary prerequisite of the solution according to the invention is that the binding agent in the paper blanks 20, 30 is still in an uncured state, that is, in a still reactive state. Only in this way is it guaranteed that the paper blanks 20, 30 can be connected to the carrier sheet 10 with sufficient strength and to each other by the recesses 15. The pulp-molding blanks 20, 30 are preferably still in a moist state before the pressing 60.

Alternatively, the carrier sheet 10 can also be coated with adhesive, for example, by a roller coating process, before it is brought into contact and pressed with the paper blanks 20, 30. During the pressing 60, not only does the binding agent react fully, but also the adhesive reacts fully during the hot-pressing. Thus the temperature must be sufficiently high. As the adhesive, preferably an adhesive based on a phenolic resin can be used that is water-based or solvent-based. Liquid adhesives can be applied on the carrier sheet 10 by spraying or a roller-coating process or by immersion. Alternatively, phenolic resin powder adhesives are used in an electrostatic application method. This additional bonding with the help of the adhesive is then performed, in particular, when the binding agent concentration or the concentration of the still reactive binding agent component is still too low before the pressing, in order to guarantee a reliable and sufficiently strong connection of the carrier sheet 10 to the paper blanks 20, 30. Someone skilled in the art must decide whether the use of adhesive is required with reference to the desired specifications for the lining disk.

During the pressing 60, the hot-pressing process fully reacts or cures the binding agent and the optional adhesive and also dries the resulting lining disk in a combined pressing, curing, bonding, and drying process.

The required groove geometries 120 on the friction surfaces 90, 110 of the friction area 70 can also be pressed during the pressing 60 by a suitable construction of the mold or can be formed by subsequent grinding. Alternatively, both friction surfaces 90, 110 could have different groove geometries 120.

For generating a defined surface structure on the friction surfaces 90, 110 or alternatively for setting the thickness, a grinding process can be performed.

A pressing 60 of two pulp-molding paper blanks 20, 30 with a carrier sheet 10 as an insert and thus without a bonding process designed as a separate processing step is provided, because the bonding is performed by the cured binding agent and the optional additional cured adhesive in one step during the pressing 60. The pressing, curing, bonding, and drying take place in a single processing step during the pressing 60.

The invention can be used advantageously for lining disks in wet-running dual clutches but also for lining disks in automatic transmissions and converter-type transmissions. It can also be used in the field of synchronization and for lining disks for differentials.

The present invention describes the production of a lining disk with a carrier sheet as an insert without the otherwise typical bonding process as a separate processing step. The pressing, curing, bonding, and drying take place in a single processing step.

### LIST OF REFERENCE NUMBERS

10 Lining carrier as a carrier sheet with recesses

15 Recess

20 First paper blank

30 Second paper blank

40 Third paper blank

50 Axis

60 Pressing (hot pressing and simultaneous drying)

70 Friction area

90 Friction surface

100 Connection area

110 Friction surface

120 Groove geometry

200 Friction body

1. A method for producing a friction body adapted to rotate about a rotational axis during operation, the friction body comprising a friction area and a connection area, and the friction body is connected to a friction body carrier by the connection area, the friction body has a lining carrier, and the lining carrier has a friction area and a connection area, and the friction body has at least two paper blanks, each of the paper blanks has a friction area, the method comprising placing a first one of the paper blanks in the friction area and placing the lining carrier in the friction area and placing a second one of the paper blanks in the friction area one above the other in an axial direction with the lining carrier being arranged axially between the first and the second paper blanks, then pressing the first paper blank and the lining carrier and the second paper blank to a specified thickness in the friction area with heating and reacting of a binding agent contained in the paper blanks to the friction body, and the binding agent contained in the paper blanks is still in a reactive state before the pressing.

2. The method according to claim 1, wherein the paper blanks are produced by a pulp-molding method.

3. The method according to claim 1, wherein the lining carrier is a carrier sheet.

4. The method according to claim 1, wherein the friction area of the lining carrier (10) has recesses.

5. The method according to claim 1, wherein the pressing is a hot-pressing process.

6. The method according to claim 1, wherein, before the first paper blank, the lining carrier, and the second paper blank are placed one above the other, the lining carrier is provided at least partially with an adhesive that is still in a reactive state and the heating during the pressing is performed such that, in addition to the reaction of the binding agent contained in the paper blanks, also a reaction of the adhesive is realized.

7. The method according to claim 1, wherein during the pressing, the friction body (200) is also dried.

8. The method according to claim 1, wherein the friction body carrier is a hub.

9. The method according to claim 1, wherein the friction area has at least one friction surface with surface structuring.

10. The method according to claim 1, wherein the friction body is a wet-running friction disk in a motor vehicle.

11. A friction body that is adapted to rotate about a rotational axis during operation, the friction body comprising a friction area and a connection area, and the friction body is connectable to a friction body carrier by the connection area, wherein the friction body including a lining carrier having a friction area and a connection area, and at least two paper blanks, each having a friction area, a first one of the paper blanks is located with the friction area thereof and the lining carrier is located in the friction area thereof and a second one of the paper blanks is located in the friction area thereof one above the other in an axial direction, with the lining carrier arranged axially between the first and the second paper blanks, the first paper blank and the lining carrier and the second paper blank are pressed to a specified thickness in the friction area with heat and reaction of a binding agent contained in the paper blanks to form the friction body, and the binding agent contained in the paper blanks being in a reactive state before the pressing.

12. The friction body of claim 11, wherein the friction body is wet-running friction disk in a motor vehicle.
